(19) United States
(12) Patent Application Publication
(10) Pub. No.: US 2015/0256343 A1
(43) Pub. Date: Sep. 10, 2015

(54) Securely Generating and Storing Passwords in a Computer System

(71) Applicant: Richard F. Graveman, Morristown, NJ (US)

(72) Inventor: Richard F. Graveman, Morristown, NJ (US)

(21) Appl. No.: 14/428,135

(22) PCT Filed: Jul. 26, 2013
(86) PCT No.: PCT/US2013/052194

§ 371 Date: Mar. 13, 2015

Related U.S. Application Data
(60) Provisional application No. 61/682,385, filed on Aug. 13, 2012.

(51) Int. Cl. H04L 9/32; H04L 9/08

(52) U.S. Cl. CPC H04L 9/3242; H04L 9/0819; H04L 2209/24

(57) ABSTRACT

Methods and systems for protecting a password are disclosed. According to one aspect of the present invention, a processor selects a set of local configuration data. This can include one or more strings associated with local configuration data. The processor concatenates the set of local configuration data and calculates a hash value of the concatenated data. The processor generates an encrypted string by using the hash value as a key to encrypt the password. Then the processor encodes the encrypted string as a string in a software program. When the password is needed by a first computer system to access a second computer system, the steps are reversed, the password obtained and the first computer system accesses the second computer system.

### STATEMENT OF RELATED CASES

The present application claims priority to and the benefit of U.S. Provisional Patent Application Ser. No. 61/652,355 filed on Aug. 13, 2012, which is incorporated herein by reference in its entirety.

### BACKGROUND

Securing passwords and other information is important to protect the security of computers. Passwords are a key defense to unwanted intrusion into a computer system. The loss of a password, often through hacking, and the resulting loss of secure information, is often disastrous, as important and highly sensitive data can be lost.

Password security issues exists even when computer systems interact. In those cases, the first computer system accessing a second computer system must still access the second computer system via a password.

When a first system automatically accesses a second system, passwords (or other authentication information, called simply passwords herein) may need to be stored in the first system rather than being entered by a person. This often increases the risk that these passwords may be acquired by anyone having access to the executable software or configuration files containing such passwords.

To reduce this risk, new and improved systems and methods to generate, store and access passwords are needed.

### SUMMARY OF THE INVENTION

The present invention processes the password using local configuration data, data concatenation, hash functions and encryption to protect passwords. This information can be stored on a first computer device. The information can be stored in memory on the first computer device as software applications. The information can also be stored in configuration files in memory on the first computer device. When a first computing device needs to access a second computing device, the first computing device reverses the process to obtain the password.

One aspect of the present invention is a method of protecting a password. A processor, under control of an instruction set in memory, selects a set of local configuration data, concatenates the set of local configuration data and calculates a hash value of the concatenated data. The processor generates an encrypted string by using the hash value as a key to encrypt the password and then encodes the encrypted string as a string in a software program.

In accordance with further aspects of the present invention, a SHA-256 hash value is calculated. Other hash values can also be calculated.

In accordance with further aspects of the present invention, an AES-256 key can be used to perform the encryption step.

The encryption step can also use ECB Mode or Counter Mode. Other key sizes, encryption methods, or modes of encryption can also be used.

The encoding step, in accordance with another aspect of the present invention uses Base 64 to perform the encoding step, although other encoding processes or none at all at this step can also be used.

The local configuration data can be constructed using different information and different processes. In accordance with one embodiment of the present invention, a CPUID instruction from the processor is used to generate a local configuration data. In accordance with another embodiment of the present invention, a 48-bit MAC address from a network interface card is used to generate the local configuration data. In a further embodiment, a software license number from an operating system is used to generate the local configuration data. In yet another embodiment, a model and serial number from a peripheral device connected to the processor is used to generate the local configuration data. These local configuration data may also be used in combination.

In accordance with further aspects of the present invention, the processor also performs the following steps when its computer system wants to access another computer system. When it needs to reconstruct the password, the processor decodes the encrypted string to get binary ciphertext, obtains the set of local configuration data and calculates the hash value to obtain a reconstructed key and then decrypts the binary ciphertext with the reconstructed key to obtain the password. Then the processor uses the password to access a computer system.

After the password has been reconstructed, the processor preferably destroys the reconstructed key. In one embodiment of the present invention, the processor erases the reconstructed key in memory. In another embodiment of the present invention, the processor writes over the reconstructed key in memory to destroy the reconstructed key.

The present invention also contemplates a system for protecting passwords. The system is a computer system that has a memory storing an instruction set and a processor in communication with the instruction set in the memory. The instruction set is operable to cause the processor to: select a set of local configuration data; concatenate the set of local configuration data and calculate a hash value of the concatenated data; generate an encrypted string by using the hash value as a key to encrypt the password; and encode the encrypted password and store the encrypted password in the memory.

In one embodiment of the present invention, the encrypted password is encoded in a software application. In another embodiment of the present invention, the encrypted password is stored in a configuration file.

When the processor needs access to the password, some time later, it decodes the encrypted string to get binary ciphertext, obtains the set of local configuration data and calculates the hash value to obtain a reconstructed key, decrypts the binary ciphertext with the reconstructed key to obtain the password, and uses the password to access a second computer.

### DESCRIPTION OF DRAWINGS

FIG. 1 illustrates storage of a password in a software application, in accordance with an aspect of the present invention.

FIG. 2 illustrates storage of a password in a configuration file, in accordance with an aspect of the present invention.

FIG. 3 illustrates a password submission protected by SSL or by TLS, in accordance with an aspect of the present invention.

FIG. 4 illustrates a protected password in a configuration file, in accordance with an aspect of the present invention.

FIG. 5 illustrates an obfuscated password, in accordance with an aspect of the present invention.

FIG. 6 illustrates a password protected by local configuration data, in accordance with an aspect of the present invention.

FIG. 7 illustrates the steps in creating and protecting a password in accordance with an aspect of the present invention.

FIG. 8 illustrates the steps in decoding a password in accordance with an aspect of the present invention.

FIG. 9 illustrates a system in accordance with an aspect of the present invention.

### DESCRIPTION

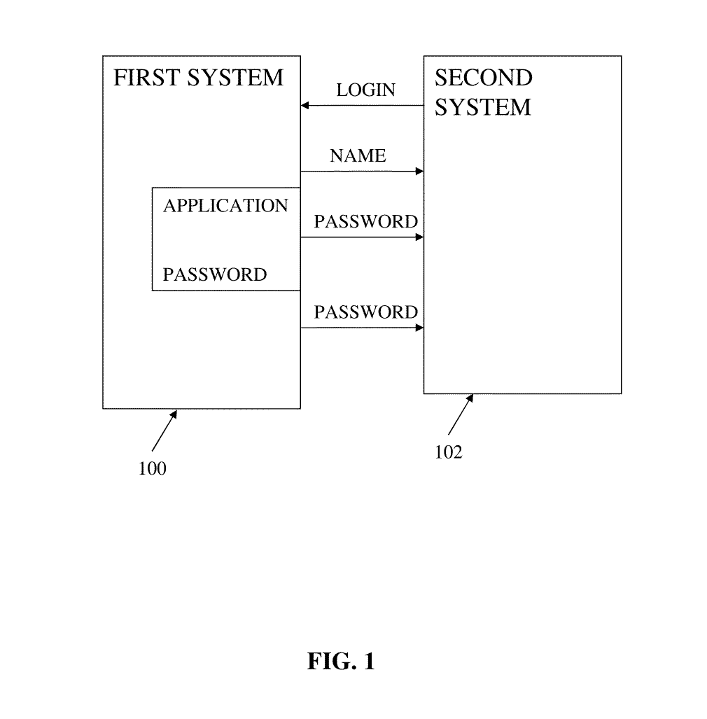

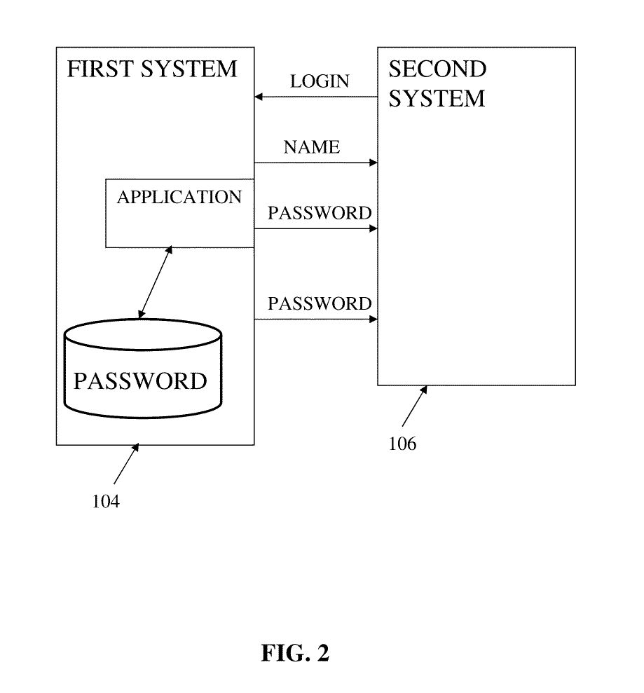

The goal of this invention is to provide methods and systems to enhance the protection of passwords and other secret symmetric keys, private keys or authentication data. The passwords can be store in software as shown in FIG. 1. In this case, the passwords can be encrypted into a string which is stored as part of a file, a software application or other software program. The passwords can also be stored in configuration files, as show in FIG. 2.

Passwords stored this way are subject to significant threats. An attacker may access, copy, and analyze software executables or configuration files that are stored on local media. This may occur because of an inside attack, a gap in the access controls protecting the software or configuration files, or access to backup copies of the software or configuration files stored elsewhere.

The attacker may access, copy, and analyze software executables or configuration files that are stored on remote media (e.g., in a distributed computing or cloud computing configuration).

The attacker may access, copy, and analyze software as images of running processes in main memory or on a paging device.

The attacker may access, copy and analyze copies of the software written after system crashes or full or partial copies of software obtained by side channel attacks or found in storage devices including DRAM after the power has been shut down.

Generally, the model described in this invention assumes that the attacker may not access, copy, or trace the running software during the operations where the password is used. Also, generally, the attacked may not simply steal the password as it is sent from the first system to the second.

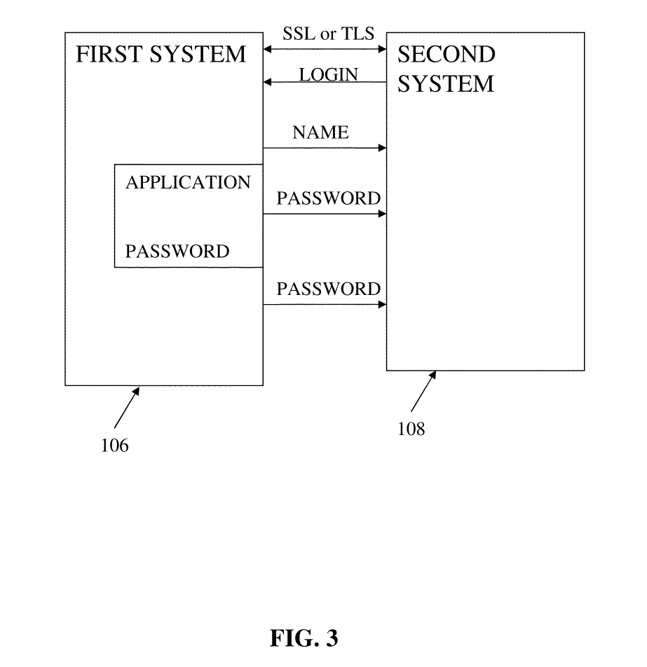

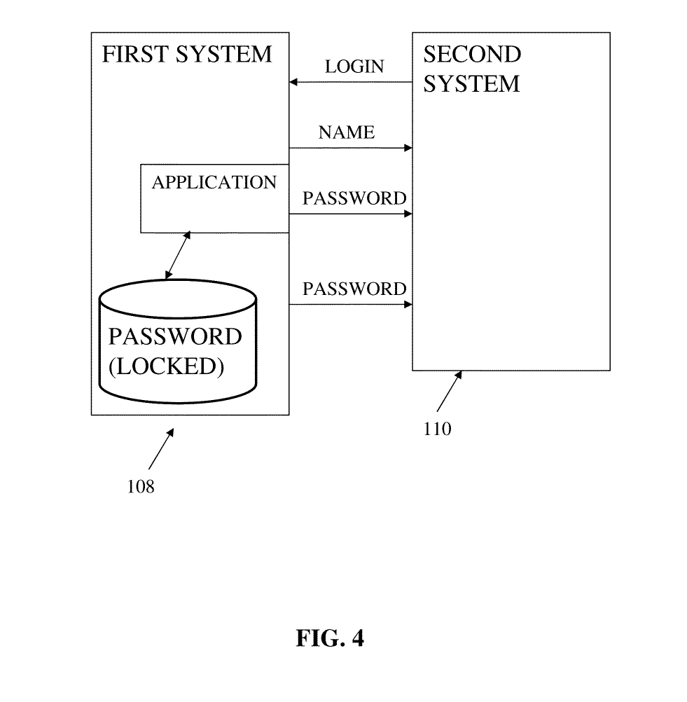

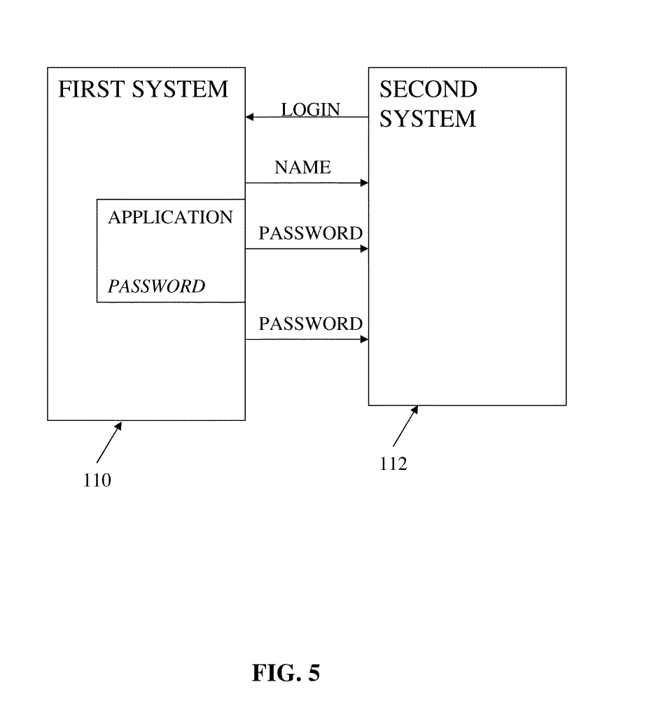

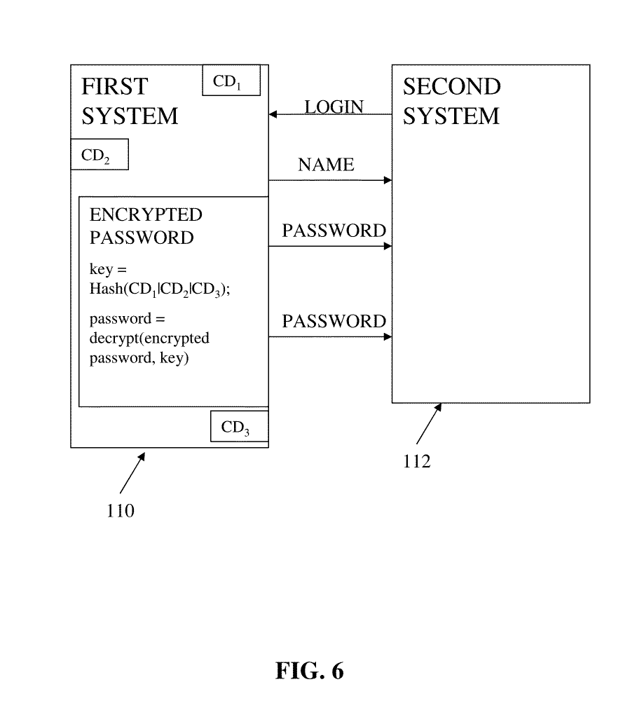

Methods exist for protecting passwords. Methods may provide for (1) controlling access to software executable files and configuration files (see FIG. 4); or (2) code obfuscation to make reverse engineering software and extracting passwords or other secret information difficult (see FIG. 5). Additionally, as shown in FIG. 3, a password submission can be protected by SSL or by TLS, in accordance with an aspect of the present invention. Also, a password can be protected within a configuration file, as shown in FIG. 6. These measures can be used, but they are preferably used in conjunction with the present invention, because, while they may be helpful, they may not be sufficient in all scenarios. Of course, a password may be encrypted, but this may simply shift the problem from protecting the password to protecting the decryption key.

The attacker may succeed in obtaining software executable files or configuration files without, however, having full access to the first system or full knowledge about how the software works. Also, the attacker in some cases may have limited, one-time access to the first system and not be able to intrude again to obtain additional information.

In addition to using whatever access controls and obfuscation methods are available, the present invention makes accessing the password (or other secret authentication data) stored in the software or configuration files of the first system depend on other system parameters that may be unavailable to the attacker or which the attacker with limited access has not obtained or cannot obtain.

When software is first installed, or when the password changes, some system management operations are needed to insert the password or other secret authentication information into the local system. If, in accordance with an aspect of the present invention, this information depends in a secure way on local configuration data that the attacker may not have, then possessing copies of the software and configuration files alone may be useless for obtaining the password or secret authentication information, and, in addition, running the software elsewhere will not allow the correct password or secret authentication information to be reconstructed, extracted or used.

The challenge faced by the present invention was to find some information specific to the local configuration that is stabile and repeatable but not easy to guess and not stored in the application software or its configuration files. Some candidates follow:

Modern CPUs from Intel and AMD have a CPUID instruction. By setting several values of a parameter and executing this instruction repeatedly, one obtains an array of information that, while not unique, may be difficult to guess precisely.

Network interface cards have a 48-bit MAC address that is globally unique. Data communications on the LAN expose this address but routed communications with other networks do not.

Operating system software may have a software license number that can be accessed.

Peripheral devices such as hard drives may have model and serial numbers or configuration information (such as interrupt vectors, addresses or priorities) accessible by software.

Special-purpose hardware can include a physical random function that returns consistent but externally unpredictable values for some constant inputs.

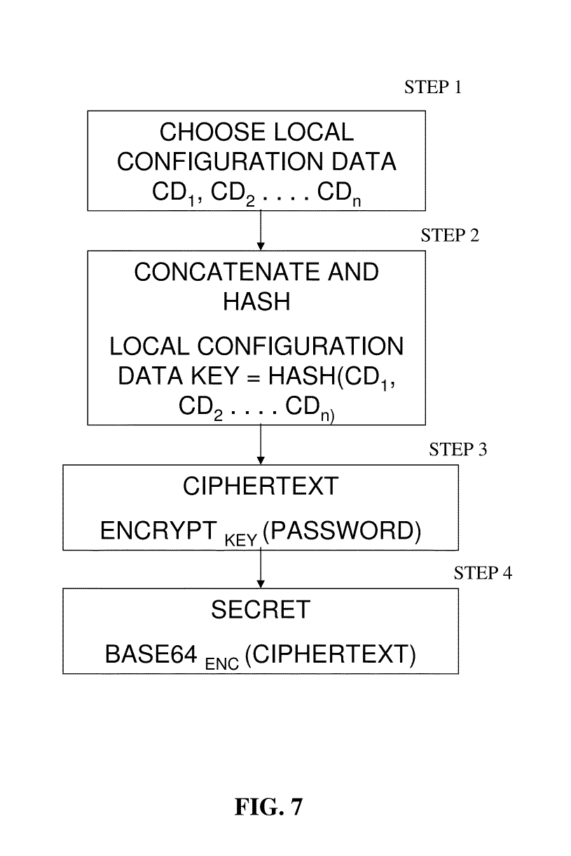

In addition to other existing protections, the following process can be used to reduce the likelihood that an attacker can extract passwords or other secret authentication data in the threat model described above. At installation, when the secret authentication information changes, or when the local configuration data change, the following steps, shown in FIG. 7, are performed in accordance with aspects of the present invention:

Step 1—Choose a set of local configuration data. The configuration data defined above, can be used. Other configuration data can also be used. It is preferred that the selected local configuration data maximize the chances of being repeatable and are not easily guessable.

Step 2—Concatenate the local configuration data and calculate a hash of the concatenated data. The SHA-256 hash can be calculated in accordance with a preferred embodiment. Other methods of processing the local configuration data, such as encrypting the data with a fixed and known key, may also be used.

Step 3—Use the hash value as the AES-256 key to encrypt the password or other secret authentication information. For small amounts of secret authentication information, ECB Mode is appropriate. For larger amounts, Counter Mode should be used. Other methods of using the processed local configuration data to encrypt the password, for example, a simple exclusive or (XOR) operation, may be used.

Step 4—Store the encrypted password in memory. Preferably, the encryption is encoded as a printable string in the software. The encoding can be Base64, for example, but other encoding can also be used. It is also preferred to apply available and prudent obfuscation to this string.

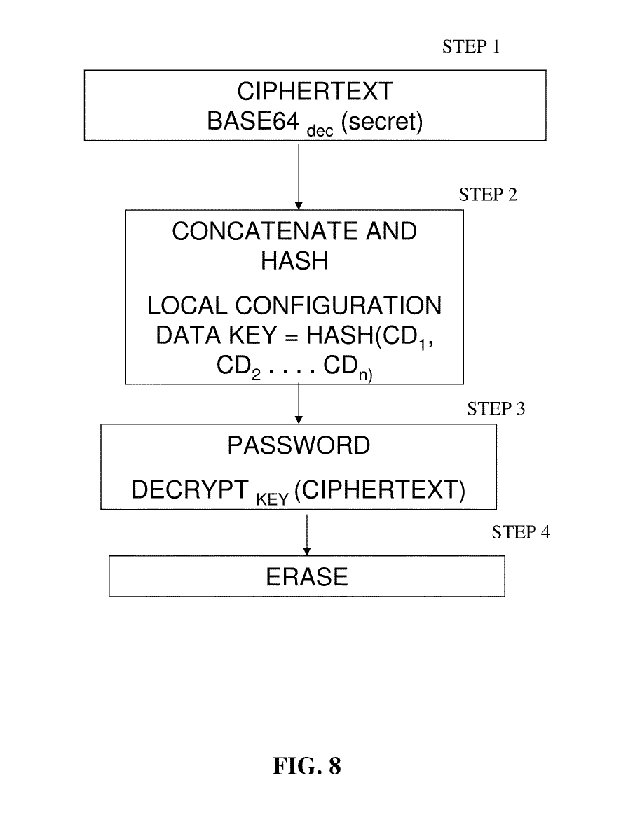

When the password is needed, the following steps, illustrated in FIG. 8, are preferably performed by the processor.

Step 1—Reverse the printable encoding to get the binary ciphertext.

Step 2—Obtain the local configuration data and compute their hash to reconstruct the key. Securely erase (overwrite) the local configuration data.

Step 3—Decrypt to obtain the password or secret authentication information and securely erase (overwrite) the key. If only a portion of the secret authentication information is needed, then only the corresponding part of the ciphertext should be decrypted.

Step 4—Use the decrypted information and securely erase (overwrite) it.

In accordance with an aspect of the invention, these steps are performed only at the time the password is needed.

Variations and extensions are possible.

This method can be extended easily when more than one password or type of secret authentication information needs to be stored. The individual passwords or other secret data items should be aligned and encrypted with an appropriate mode so that they can be decrypted separately when needed.

Different hash functions and encryption methods ma be used. SHA-2 and AES-256 are a natural fit but only an example. The purpose of the hash function is to extract uniform pseudo-random bits from the local configuration data. If the password is not too long, then it can simply be exclusive ORed with the output of the hash function. If the hash function is needed more than once, a counter can be concatenated to the local configuration data. In fact, a block cipher such as AES is not needed at all. It is only included to provide a pseudo-random function. Other types of randomness extraction and masking are well known to cryptographers. Another simple and good approach is Krawczyk's extract-and-expand construction. Because this uses only a hash function and no block cipher, it may be subject to fewer export restrictions. (See http://webee.technion. ac.il/˜hugo/kdf/kdf.pdf).

It may be difficult to guarantee that the local configuration data can be reconstructed exactly. The following extensions to the above steps may be used. At installation, construct an error correcting code such that the local configuration data constitute a codeword. When the local configuration data are later retrieved and reconstructed, apply the error correcting code and hope that they decode to the original codeword. Additional redundancy can be used to help determine whether this step was successful. If it can be determined how the local configuration data have changed, then it may be possible to “re-center” the error correcting code around the “new” local configuration data, to reconfigure the system automatically, and to adapt to a sequence of changes in the local configuration data. Note that this added redundancy may not be free. The error correcting code may help the attacker to reverse engineer the local configuration data. For more details about this process, the research literature on “fuzzy extractors” should be consulted. Note, however, that the concept of a “robust fuzzy extractor” is not needed in this application. In accordance with an aspect of the present invention, list decoding may be a good choice here, because the application can tolerate trying to decode correctly more than once.

Various alternative choices of local configuration data may exist. The security requirement is characterized by min-entropy. The application and configuration of the first system should be considered when choosing what to use.

Systems may have more than one MAC address, so a method is needed to choose one or even to use more than one.

The reasons for the Base64 or other encoding is to avoid storing random binary data that is easily found by reverse engineering searches.

It may be advisable not to make the crypto too efficient. In fact, slowing it down artificially may be advantageous. If the attacker needs 100,000,000 guesses to find the local configuration data and the crypto takes 1 second, the system is quite secure. If the crypto takes 1 millisecond, it is much less so.

The actual transmission of the password from the first system to the second should, if possible, be protected by additional means such as SSL-TLS. This is illustrated in FIG. 3. Of course, the SSL-TLS connection needs to be authenticated, but not necessarily by sending a password.

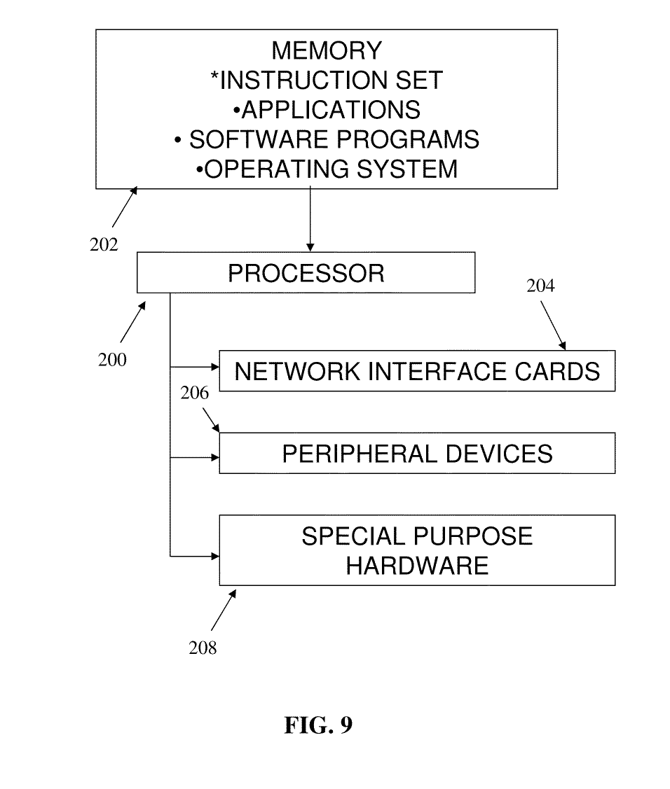

FIG. 9 illustrates a system used in accordance with an aspect of the present invention. The system includes a processor 200 in communication with memory 202, network interface cards 204, peripheral devices 206 and special purpose hardware 208. The memory stores many different types of information, including operating system software, software applications and programs and an instruction set to cause the processor 200 to perform a number of steps, including those described herein and shown in FIGS. 7 and 8. The software programs in the memory 202 typically have configuration words associated with them that can be used to implement aspects of the present invention, as described herein.

The peripheral devices 206 include a wide range of devices, including but not limited to, hard drives and printers. These devices 206 also have configuration words associated with them that can be used to implement aspects of the present invention, as described herein. Likewise, the network interface cards 204 and the special purpose hardware 208 also have configuration words associated with them that can be used to implement aspects of the present invention, as described herein. Essentially, any hardware or software connected to the processor 200 that has configuration words of any type can be used to implement aspects of the present invention described herein.

When passwords are used in automatic systems, there is not requirement that they have human mnemonic properties or other such restrictions. Avoiding any such artificial restrictions may strengthen the method described.

Other approaches to this problem based on a single sign-on technology or secure hardware such as trusted platform systems are somewhat different and possibly complementary with this approach.

While there have been shown, described and pointed out fundamental novel features of the invention as applied to preferred embodiments thereof, it will be understood that various omissions and substitutions and changes in the form and details of the methods and systems illustrated and in its operation may be made by those skilled in the art without departing from the spirit of the invention. It is the intention, therefore, to be limited only as indicated by the claims.

1. A method of protecting a password in a computer, comprising a processor:
selecting a first local configuration word associated with the computer as a data word;
applying a hash function to the data word to calculate a hash value; and
generating an encrypted string by using the hash value as a key to encrypt the password; and
storing the encrypted string in a memory in the computer.

2. The method of claim 1, comprising the processor, encoding the encrypted string as a string in a software program which is stored in the memory.

3. The method of claim 1, wherein the processor concatenates a second local configuration word with the first local configuration word to generate the data word.

4. The method of claim 1, wherein a SHA-256 hash value is calculated.

5. The method of claim 1, wherein the key is a AES-256 key.

6. The method of claim 1, wherein the encoding step uses Base64.

7. The method of claim 1, wherein a CPUID instruction from the processor is used to generate the first local configuration word.

8. The method of claim 1, wherein a 48-bit MAC address from a network interface card is used to generate the first local configuration word.

9. The method of claim 1, wherein a software license number from an operating system is used to generate the first local configuration word.

10. The method of claim 1, wherein a model and serial number from a peripheral device connected to the processor is used to generate the first local configuration word.

11. The method of claim 1, further comprising the processor performing the steps of:
decoding the encrypted string to get binary ciphertext;
obtaining the data word and calculating the hash value using the hash function to obtain a reconstructed key;
decrypting the binary ciphertext with the reconstructed key to obtain the password.

12. The method of claim 11 comprising the processor using the password to access a computer system.

13. The method of claim 11, wherein the reconstructed key is stored in a memory by the processor and, after using the reconstructed key, the processor erases the reconstructed key from the memory.

14. The method of claim 13, wherein the processor erases the reconstructed key by writing over the reconstructed key in the memory.

15. A computer system having a plurality of associated local configuration words, comprising:
a memory having an instruction set stored in it;
a processor in communication with the instruction set in the memory, the instruction set operable to cause the processor to:
generate a data word from one of the local configuration words;
calculating a hash value from the data word;
generate an encrypted string by using the hash value as a key to encrypt the password; and
store the encrypted string in the memory.

16. The computer system of claim 15, wherein the instruction set causes the encrypted string in a software program which is stored the encrypted string in the memory.

17. The computer system of claim 15, wherein the data word is generated from one or more other of the local configuration words, the local configuration words being concatenated to generate the data word.

18. The computer system of claim 15 wherein the encrypted string is stored in a configuration file.

19. The computer system of claim 15 wherein the local configuration data word and the second local configuration data word are selected from the group consisting of: a string generated by using a CPUID instruction from the processor, a string generated by processing a 48-bit MAC address from a network interface card, a string generated by processing a software license number from an operating system, a string generated by processing a model and serial number from a peripheral device connected to the processor, and a string generated by processing model or serial numbers or interrupt vectors or addresses or priorities of the peripheral device.

20. The computer system of claim 15 wherein the processor, some time later, decodes the encrypted string to get binary ciphertext, obtains the local configuration word and the second local configuration word, concatenates the local configutation word and the second local configuration word, calculates the hash value to obtain a reconstructed key, decrypts the binary ciphertext with the reconstructed key to obtain the password, and uses the password to access a second computer.

21. A system, comprising:
a first computer having a memory with an instruction set and a processor in communication with the instruction set, and
a second computer that can be accessed with a password,
wherein the processor, under control of the instruction set, is operable to select a set of local configuration data, to concatenate the set of local configuration data and to calculate a hash value of the concatenated data, to generate an encrypted string by using the hash value as a key to encrypt the password and to encode the encrypted string as a string in a software program
wherein the processor, some time later under control of the instruction set, is operable to decode the encrypted string to get binary ciphertext, to obtain the set of local configuration data and calculates the hash value to obtain a reconstructed key, to decrypt the binary ciphertext with the reconstructed key to obtain the password, and to use the password to access the second computer.
